(19) United States
(12) Patent Application Publication
(10) Pub. No.: US 2005/0132326 A1
(43) Pub. Date: Jun. 16, 2005

(54) Software development tool for ensuring links between uml models and the implementation thereof in a cobra environment

(76) Inventors: Stephen Chischportich, Paris (FR); Emilie Sayag, St Michel Sur Orge (FR); Ludovic Depitre, Paris (FR)

Correspondence Address: SUGHRUE MION, PLLC, 2100 PENNSYLVANIA AVENUE, N.W., SUITE 800, WASHINGTON, DC, 20037, US

(21) Appl. No.: 10/513,475

(22) PCT Filed: May 20, 2003
(86) PCT No.: PCT/FR03/01511

(30) Foreign Application Priority Data
May 23, 2002 (FR) 0206287

(51) Int. Cl. G06F 9/44

(52) U.S. Cl. 717/106; 717/136

(57) ABSTRACT

The invention consists in automatically equipping the UML implementation model from UML interface models (MA) according to a UML relation present between each class of interface and the class of implementation thereof, in addition to using said link to generate the implementation code (M1) with CORBA specificity. The invention also relates to the transformation and instrumentation of a server application and also to the transformation and instrumentation of client application.

The invention relates to a software development tool for ensuring links between UML models of CORBA interfaces and their implementation.

UML stands for Unified Modelling Language.

CORBA stands for Common Object Request Broker Architecture.

IDL stands for Interface Description Language.

The UML language provides efficient means for specifying software systems and describing a model of these systems. Some software workshops, in other words software application development tools, enable code generation starting from the UML model.

At least two models must be defined for the development of a distributed system based on CORBA and according to a UML process, with one model to specify IDL interfaces and another model to define their implementation.

Software workshops propose solutions to describe the two sorts of models and generate the IDL code and code implementation from these models.

But these tools cannot be used to equip the UML interface model to make a link with the UML implementation model, and the two models remain completely independent. This requires that an implementation code that does not include specific CORBA features of the system should be generated.

The only existing solution to create a link between the UML model of IDL interfaces of a distributed system and the UML model of the implementation of this system is to:
generate the interfaces IDL code from the UML model,
compile these interfaces with an ORB (Object Request Broker),
use a reverse engineering phase to obtain an UML model of the implementation from the generated code.

The solution described above is only a partial solution to the problem since it only links the UML models and it cannot be used to equip the UML interface model to generate an implementation code related to these interfaces.

Moreover, this solution depends very strongly on the quality of the reverse engineering phase starting from the generated code. Manual execution of such a phase can guarantee good quality but it will remain fairly inefficient, and automation using a software workshop does not yet provide the required quality and requires manual feedback on the model obtained.

Another disadvantage is due to the fact that with this solution, there is no dependence between the interface model and the implementation model. Thus any changes (even minor) in the interfaces of the UML model are difficult to transfer to the implementation model.

This invention consists firstly of automatically equipping the UML implementation model from the UML interface model, using a UML relation present between each interface class and its implementation class and secondly to use this link to generate the implementation code with CORBA specific features.

The invention is applicable to transformation and instrumentation of a server application and also to transformation and instrumentation of client applications.

Therefore, the invention also relates to a software development tool to ensure links between UML models of CORBA interfaces and client implementations.

Note more precisely that at least the following two models must be defined for the development of a system of distributed objects in the Corba environment with the UML language:
a model called the analysis model in which interfaces and their relations with other high level classes describe the application;
a model called the implementation model in which all application classes are mentioned. A large number of technical classes are added in this model.

Therefore, according to another characteristic of the invention, it is proposed to ensure a link between the UML implementation model starting from the analysis model.

Note also that a “CORBA Messaging” document (contained in the CORBA 2.4 specification) provides four different models to invoke an interface to a client, namely:
synchronous (or two-directional) invocation,
single-directional invocation,
asynchronous invocation with the “callback” model;
asynchronous invocation with the “polling” model.

Asynchronous invocations require a specific class implementation to process the responses.

Therefore according to the invention, it is proposed to stereotype the UML “use” relation for asynchronous invocations, between a class (or method) and an interface.

The UML label on this “use” relation specifies the characteristic of this asynchronous relation which may be “callback” or “polling”.

Thus, we will automatically construct the implementation model starting from the analysis model. As will be seen in the following, this will consist of creating a class called “callback” or “polling” from interfaces, according to CORBA 2.4 specific features and the C++ language. We will also generate the corresponding code based on CORBA 2.4 specific features and the C++ language.

Therefore, the purpose of the invention is a software development tool including means for designing UML interface objects and generating them in IDL language, characterised mainly in that it comprises:
means of designing UML implementation objects and generating the corresponding implementation source code (C++),
and in that the UML interface objects and UML implementation objects are linked as early as the design phase.

According to another characteristic, UML implementation objects and UML interface objects are linked by a UML relation present between each interface class and the corresponding implementation class, this link being used to generate the implementation code with CORBA specific features.

One UML interface object is the model specifying IDL (Interface Description language) interfaces of a distributed system, and the other object defines their implementation.

This UML interface object is the analysis model in which the interfaces and their relations with other high level classes describe the client application, the other object being the implementation model in which all application classes are mentioned.

Other specific features and advantages of the invention will become clearer after reading the following description given as a non-limitative example with reference to the drawings, wherein:

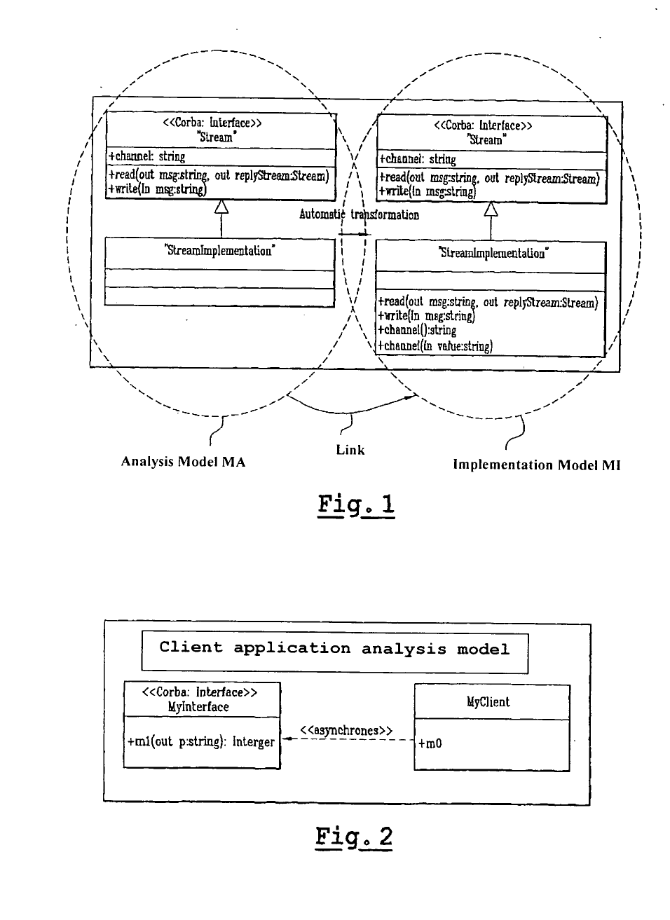

FIG. 1 is a diagram illustrating the development tool for transformation and instrumentation of a class that implements an interface starting from an analysis model;

FIG. 2 diagrammatically shows the analysis model of a client application;

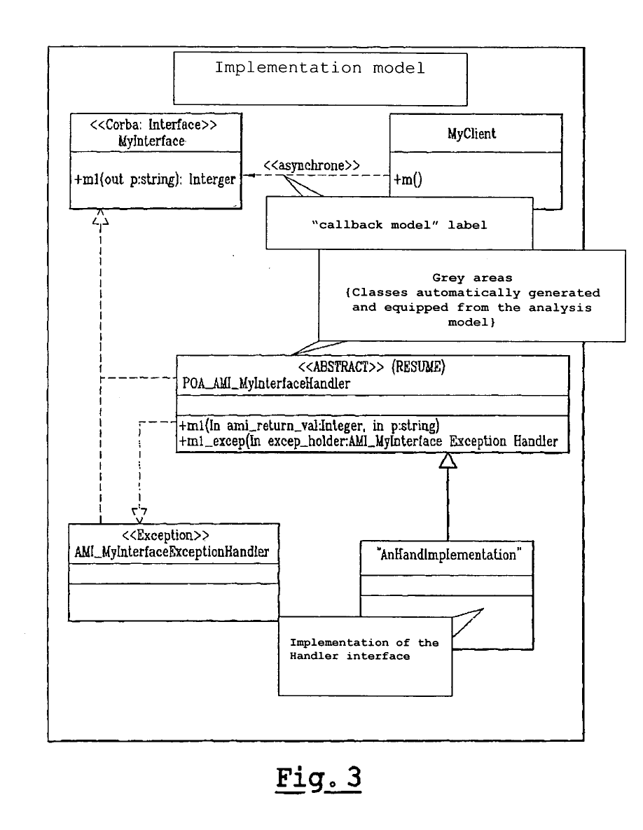

FIG. 3 diagrammatically illustrates the development tool for transformation and instrumentation of the client application shown in FIG. 2.

According to the invention, it is proposed to automatically equip the UML implementation model starting from the UML interface model, shown as reference MA in FIG. 1, using a UML relation present between each interface class and its implementation class. It is also proposed to use this link to generate the implementation code with the CORBA specific features.

As defined by the OMG (Object Management Group) in the UML for CORBA profile, in a UML model, IDL interfaces must be described by stereotyped “CORBA” interface classes.

We will do this using a UML “realize” link (implementation link) between the interfaces and the corresponding implementation classes. This link automatically associates implementation methods related to the description of the IDL interface.

For each operation defined in an IDL interface, a method with the same name and the right signature is automatically generated in the corresponding implementation class. Two access methods are defined in the implementation class for each attribute of an IDL interface, to set up and obtain the value of this attribute.

The invention is equally applicable to server applications and to client applications.

FIG. 1 shows an example of a server application. The diagram in this Figure illustrates the transformation and instrumentation of a class that implements a “Stream” interface starting from an analysis model MA.

According to the particular example illustrated in this Figure, the four methods of the “Stream Implementation” implementation class and their signature were added automatically using the link made between each class.

The solution also consists of modifying generation of the implementation classes code to take account of CORBA specific features. For example, the generator automatically manages naming spaces, signatures and inheritance of CORBA objects from the model.

In the previous example, if the “stream” interface belongs to a CORBA “Messaging” module, the generated “StreamImplementation” class in C++ inherits from the “::POA-Messaging::Stream” class.

For the model in the previous example, the generated C++ code is as described in the appendix to the description.

The invention is also described later for an analysis model MA for a client application. The analysis model for the client application is illustrated in FIG. 2, and FIG. 3 shows the transformation and instrumentation of this client application to determine how the client will use the interface.

As already described, it is an analysis model in which the interfaces and their relations with other high level classes describe the application.

The UML “use” relation between two classes or between a method and a class means that the method (or methods in the class) uses the denoted class. If this denoted class is a stereotyped CORBA interface, the method uses an interface.

Therefore, it is proposed to define how this interface will be used (synchronous or asynchronous) in the analysis model, by adding a stereotype called “asynchronous” in the UML “use” relation. The “asynchronous” stereotype is used with a UML label called “callback model” or “polling model”. This label indicates how the implementation model is built up.

There is no difference between the analysis model and the implementation model MI for single directional and two-directional invocations. The C++ generation code must simply add the contents of the corresponding “stub” (the corresponding element), into the body of the class that uses the interfaces.

For example, as can be seen illustrated in FIG. 2, the analysis model shows that method m( ) of class “MyClient” uses an interface called “MyInterface”. On this link, the “asynchronous” stereotype uses the “callback model” label to specify the manner in which the “MyInterface” interface is used.

This link provides a means of automatically modifying the UML model and creating the “ReplyHandler” class with corresponding methods as defined by the CORBA Messaging standard.

In the case of an asynchronous invocation with a “polling” model, it is proposed to add a “Corba: ami_poller” stereotype on the “use” link and it is proposed to add the “Corba: ami_callback” stereotype for the “callback” model.

With this information, the UML model contains enough information to modify the implementation model.

According to the CORBA Messaging specific features, classes must be included in the new UML model. These classes are linked to their interface through an implementation link in order to guarantee consistency between the two models.

A stereotyped “CORBAInterface” class that includes a stereotyped “asynchronous” “use” relation adds an option into the IDL compiler to specify that it must generate skeletons and specific “stubs” with the added “Messaging” module, in order to generate the IDL code.

Classes use a “nocode” and “AMIPoller” or “AMIHandler” label, in order to implement generation of the C++ code.

Labels are used so that generation of the C++ code can take account of rules and syntax specified in the “CORBA Messaging mapping for C++” document published by the OMG.

### APPENDIX

APPENDIX

Class StreamImplantation: public : : POA-Messaging : :
Stream
{

void read(
char*_out msg,
Messaging : : Stream_out replyStream)
{...} ;
void write(
const char* msg,
{...} ;
void* channel()
{...} ;
void channel(
const char* value,
{...} ;

} ;

1. Software development tool including means for designing UML interface objects and generating them in IDL language, characterised in that it comprises:
means of designing UML implementation objects and generating the corresponding implementation source code (C++),
and in that the UML interface objects and UML implementation objects are linked as early as the design phase.

2. Software development tool according to claim 1, characterised in that the UML implementation objects and the UML interface objects are linked by a UML relation present between each interface class and the corresponding implementation class, this link being used to generate the implementation code with CORBA specific features.

3. Software development tool according to claim 1, characterised in that one UML interface object is the model specifying IDL (Interface Description language) interfaces of a distributed system, and the other object defines their implementation.

4. Software development tool according to claim 1, characterised in that this UML interface object is the analysis model in which the interfaces and their relations with other high level classes describe the client application, and the other object is the implementation model in which all application classes are mentioned.
